(19) United States
(12) Patent Application Publication
(10) Pub. No.: US 2025/0378348 A1
(43) Pub. Date: Dec. 11, 2025

(54) CROSS-DOMAIN TRANSFER METHOD, APPARATUS AND DEVICE FOR PREDECTION MODEL AND STORAGE MEDIUM

(71) Applicant: BEIHANG UNIVERSITY, Beijing (CN)

(72) Inventors: Lei REN, Beijing (CN); Zidi Jia, Beijing (CN)

(21) Appl. No.: 19/000,391

(22) Filed: Dec. 23, 2024

(30) Foreign Application Priority Data
Jun. 7, 2024 (CN) 202410733667.6

(51) Int. Cl. G06N 3/096

(52) U.S. Cl. CPC G06N 3/096

(57) ABSTRACT

A cross-domain transfer method, apparatus and device for a prediction model, and a storage medium, including: acquiring source domain data in a source domain, determining a contrastive domain generalization loss according to a first latent feature and a label of the source domain data, pre-training a source domain model to obtain a pre-trained model, and transferring the pre-trained model to a target domain to make the pre-trained model adapted to the target domain and form a target domain model; acquiring target domain data, determining a second latent feature and a pseudo label of the target domain data, determining an instance-wise adversarial loss, a self-supervised alignment loss, and a pseudo domain generalization loss of the target domain data according to the second latent feature, pseudo label, source domain data, first latent feature and label, and performing calibrating processing on the target domain model to obtain a target model.

### CROSS-REFERENCE TO RELATED APPLICATIONS

This application claims priority to Chinese Patent Application No. 2024107336676, filed on Jun. 7, 2024, which is hereby incorporated by reference in its entirety.

### TECHNICAL FIELD

The present application relate to the field of communication technology and, in particular, to a cross-domain transfer method, apparatus and device for a prediction model, and a computer storage medium.

### BACKGROUND

Cross-domain transfer refers to a process of applying a model that has already been trained in one domain to another domain. The cross-domain transfer involves two key concepts: a source domain and a target domain. The source domain refers to a domain that already has sufficient data, while the target domain refers to a new domain whose performance needs to be improved. A main process is to achieve better performance in the target domain by learning knowledge from the source domain. In industrial field, due to a high cost of data acquisition and annotation, there is usually a large amount of unlabeled data, and in a practical application, it may be necessary to transfer an existing model to a new industrial scenario.

Cross-domain transfer techniques typically include methods such as domain adaptation and transfer learning. The domain adaptation aims to reduce a distribution difference between the source domain and the target domain, in order to improve a generalization capability of the model on the target domain. The transfer learning helps with a learning task in the target domain by utilizing the knowledge of data in the source domain, reducing a requirement for data in the target domain. This mainly includes: training a model in the source domain; transferring a source domain model to the target domain for fine-tuning.

Existing industrial data prediction methods usually assume that monitored data follows an assumption of being independent and identically distributed, but due to a complexity and variability of industrial processes, this is usually not true. The monitored data may exhibit a distribution bias, leading to a decrease in the performance of a prediction model. Although there are many mature transfer learning methods, most of them are designed for a classification task, and there are few methods developed for a regression prediction task. Most transfer learning methods cannot be used for a regression task.

### SUMMARY

The present application provides a cross-domain transfer method, apparatus and device for a prediction model, and a storage medium, in order to solve a problem of decreased predictive performance of a model and an unsuitability of the cross-domain transfer method when predicting complex and diverse industrial data.

In a first aspect, the present application provides a cross-domain transfer method for a prediction model, applied to a source domain, where the source domain includes a source model, and the source model includes a source domain encoder, a source domain predictor and a source domain mapping module, and the method includes:
acquiring source domain data, inputting the source domain data into the source domain encoder to obtain a first latent feature of the source domain data;
inputting the first latent feature into the source domain predictor to obtain a label of the source domain data, and determining a prediction loss corresponding to the label;
inputting the first latent feature into the source domain mapping module to obtain a first mapping representation of the first latent feature, and determining a contrastive domain generalization loss of the label according to the first mapping representation;
pre-training the source domain model according to the prediction loss and the contrastive domain generalization loss to obtain a pre-trained model;
sending the pre-trained model to a target domain, enabling the target domain to perform domain alignment processing according to the pre-trained model.

In an implementation, the pre-trained the source domain model according to the prediction loss and the contrastive domain generalization loss to obtain the pre-trained model includes:
integrating the prediction loss with the contrastive domain generalization loss to determine an integration result;
updating a parameter of the source domain model according to the integration result to obtain the pre-trained model.

In a second aspect, the present application provides a cross-domain transfer method for a prediction model, applied to a target domain and including:
acquiring target domain data, a source domain data set sent by a source domain, and a pre-trained model, where the pre-trained model includes an encoder and a predictor, and the source domain data set includes source domain data, a first latent feature of the source domain data, and a first mapping representation of the source domain data;
performing adaptive processing on the pre-trained model to obtain a target domain model, where the target domain model includes an encoder, a predictor, a domain adversarial discriminator, and a target domain mapping module;
inputting the target domain data into the encoder to obtain a second latent feature of the target domain data;
inputting the second latent feature into the predictor to obtain a pseudo label of the target domain data;
inputting the pseudo label, the second latent feature, and the first latent feature into the domain adversarial discriminator to obtain an instance-wise adversarial loss of the target domain data;
inputting the second latent feature into the target domain mapping module to determine a second mapping representation of the second latent feature;
determining a self-supervised alignment loss of the target domain data according to the source domain data, the target domain data, the first latent feature, the second latent feature, the first mapping representation, and the second mapping representation;
determining a pseudo domain generalization loss of the target domain data according to the target domain data, the second mapping representation, and the pseudo label;
performing calibrating processing on the target domain model according to the instance-wise adversarial loss, the self-supervised alignment loss, and the pseudo domain generalization loss to obtain a target model, where the target model includes a calibrated encoder and a calibrated predictor.

In an implementation, the inputting the pseudo label, the second latent feature, and the first latent feature into the domain adversarial discriminator to obtain the instance-wise adversarial loss of the target domain data, includes:
determining weights of the source domain data and the target domain data according to the pseudo label;
inputting the weights, the second latent feature, and the first latent feature into the domain adversarial discriminator to determine the instance-wise adversarial loss of the target domain data.

In an implementation, the inputting the weights, the second latent feature, and the first latent feature into the domain adversarial discriminator to determine the instance-wise adversarial loss of the target domain data, includes:
determining the instance-wise adversarial loss using the following formula:

$${ℒ}_{iadv} = arg {min}_{{5}^{T}} {max}_{D} [ {𝔼}_{X} s [ log ( {w}^{S} ⋆ D ( {E}^{S} ( {X}^{S} ) ) ) ] + {𝔼}_{{X}^{T}} [ log ( {w}^{T} ⋆ ( 1 − D ( {E}^{T} ( {X}^{T} ) ) ) ) ]$$

$${w}_{i}^{S} = φ \cdot \frac{{\sum }_{k} exp ( − \vert {\hat{y}}_{i} − {\hat{y}}_{k} \vert / L )}{{n}^{T}} + ( 1 − φ )$$

$${w}_{k}^{T} = φ \cdot \frac{{\sum }_{i} exp ( − \vert {\hat{y}}_{k} − {\hat{y}}_{i} \vert / L )}{{n}^{S}} + ( 1 − φ )$$

where [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain,

$${w}_{i}^{S}$$

is a weight of i-th data in the source domain data,

$${W}_{k}^{T}$$

is a weight of k-th data in the target domain data, ŷᵢ and ŷₖ are pseudo labels of the i-th data in the source domain data and the k-th data in the target domain data respectively, L is an approximate value range of the label, φ is a hyperparameter, E^{S} is a source domain encoder, E^{T} is the encoder, X^{S} is the first latent feature, X^{T} is the second latent feature.

In an implementation, the determining the self-supervised alignment loss of the target domain data according to the source domain data, the target domain data, the first latent feature, the second latent feature, the first mapping representation, and the second mapping representation, includes:
determining the self-supervised alignment loss using the following formula:

$${ℒ}_{C S A} = arg {min}_{{E}^{T} , {M}^{T}} {𝔼}_{\vert X ∈ \{ {X}^{S} ⋃ {𝒳}^{T} \}} − log {\sum }_{i} [ \frac{{\sum }_{k} exp ( − {τ}_{1} {sim}_{i , k} \cdot {‖ {X}_{i} − {X}_{k} ‖}_{2} )}{{\sum }_{j} exp ( − {τ}_{1} {‖ {X}_{i} − {X}_{j} ‖}_{2} )} + {ε}_{1} ]$$

$${sim}_{i , k} = exp ( − {‖ {m}_{i} − {m}_{k} ‖}_{2} )$$

$${H}_{i}^{T} = {E}^{T} ( {X}_{i}^{T} )$$

where [symbol] _{CSA} is the self-supervised alignment loss, E^{T} is the encoder, M^{T} is the target domain mapping module, E is the representation symbol for all encoders, i, k and j are sequential numbers of the data, X is the source domain data and the target domain data, X^{S} is the source domain data set, X^{T} is a target domain data set, sim_{i,k}: is a density ratio, m is a scaling of a latent feature H by a mapping module,

$${H}_{i}^{T}$$

is a latent feature of a sample Xᵢ, and τ₁ and ε₁ are hyperparameters.

In a third aspect, the present application provides a cross-domain transfer apparatus for a prediction model, applied to a source domain, where the source domain includes a source model, and the source model includes a source domain encoder, a source domain predictor and a source domain mapping module, and the apparatus includes:
an acquiring module, configured to acquire source domain data, input the source domain data into the source domain encoder to obtain a first latent feature of the source domain data;
an input module, configured to input the first latent feature into the source domain predictor to obtain a label of the source domain data, and determine a prediction loss corresponding to the label;
the input module is further configured to input the first latent feature into the source domain mapping module to obtain a first mapping representation of the first latent feature, and determine a contrastive domain generalization loss of the label according to the first mapping representation;
a processing module, configured to pre-train the source domain model according to the prediction loss and the contrastive domain generalization loss to obtain a pre-trained model;
a sending module, configured to send the pre-trained model to a target domain, enabling the target domain to perform domain alignment processing according to the pre-trained model.

In an implementation, the processing module is further configured to integrate the prediction loss and the contrastive domain generalization loss to determine an integration result;
the processing module is further configured to update a parameter of the source domain model according to the integration result to obtain the pre-trained model.

In a fourth aspect, the present application provides a cross-domain transfer apparatus for a prediction model, applied to a target domain, including:
an acquiring module, configured to acquire target domain data, a source domain data set sent by a source domain, and a pre-trained model, where the pre-trained model includes an encoder and a predictor, and the source domain data set includes source domain data, a first latent feature of the source domain data, and a first mapping representation of the source domain data;
a processing module, configured to perform adaptive processing on the pre-trained model to obtain a target domain model, where the target domain model includes an encoder, a predictor, a domain adversarial discriminator, and a target domain mapping module;
an input module, configured to input the target domain data into the encoder to obtain a second latent feature of the target domain data;
the input module is further configured to input the second latent feature into the predictor to obtain a pseudo label of the target domain data;
the input module is further configured to input the pseudo label, the second latent feature, and the first latent feature into the domain adversarial discriminator to obtain an instance-wise adversarial loss of the target domain data;
the input module is further configured to input the second latent feature into the target domain mapping module to determine a second mapping representation of the second latent feature;
a determining module, configured to determine a self-supervised alignment loss of the target domain data according to the source domain data, the target domain data, the first latent feature, the second latent feature, the first mapping representation, and the second mapping representation;
the determining module is further configured to determine a pseudo domain generalization loss of the target domain data according to the target domain data, the second mapping representation, and the pseudo label;
the determining module is further configured to perform calibrating processing on the target domain model according to the instance-wise adversarial loss, the self-supervised alignment loss, and the pseudo domain generalization loss to obtain a target model, where the target model includes a calibrated encoder and a calibrated predictor.

In an implementation, the determining module is configured to determine weights of the source domain data and the target domain data according to the pseudo label;
the input module is further configured to input the weights, the second latent feature, and the first latent feature into the domain adversarial discriminator to determine the instance-wise adversarial loss of the target domain data.

In an implementation, the input module is further configured to input the second latent feature, and the first latent feature into the domain adversarial discriminator to determine the instance-wise adversarial loss using the following formula:

$${ℒ}_{iadv} = arg {min}_{{E}^{T}} {max}_{D} [ {𝔼}_{{X}^{S}} [ log ( {w}^{S} * D ( {E}^{S} ( {X}^{S} ) ) ) ] + [ {𝔼}_{{X}^{T}} [ log ( {w}^{T} * ( 1 - D ( {E}^{T} ( {X}^{T} ) ) ) ) ]$$

$${w}_{i}^{S} = φ \cdot \frac{{\sum }_{k} exp ( - \vert {\hat{y}}_{i} - {\hat{y}}_{k} \vert / L )}{{n}^{T}} + ( 1 - φ )$$

$${w}_{k}^{T} = φ \cdot \frac{{\sum }_{i} exp ( - \vert {\hat{y}}_{k} - {\hat{y}}_{i} \vert / L )}{{n}^{S}} + ( 1 - φ )$$

where [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain,

$${w}_{i}^{S}$$

is a weight of i-th data in the source domain data,

$${w}_{k}^{T}$$

is a weight of k-th data in the target domain data, ŷᵢ and ŷₖ are pseudo labels of the i-th data in the source domain data and the k-th data in the target domain data respectively, L is an approximate value range of the label, φ is a hyperparameter, E^{S} is a source domain encoder, E^{T} is the encoder, X^{S} is the first latent feature, X^{T} is the second latent feature.

In an implementation, the determining module is further configured to determine the self-supervised alignment loss using the following formula:

$${ℒ}_{CSA} = arg {min}_{{E}^{T} , {M}^{T}} {𝔼}_{\vert X ∈ \{ {𝒳}^{S} ⋃ {𝒳}^{T} \}} - log {\sum }_{i} [ \frac{{\sum }_{k} exp ( - {τ}_{1} {sim}_{i , k} \cdot {‖ {X}_{i} - {X}_{k} ‖}_{2} )}{{\sum }_{j} exp ( - {τ}_{1} {‖ {X}_{i} - {X}_{j} ‖}_{2} )} + {ε}_{1} ]$$

$${sim}_{i , k} = exp ( - {‖ {m}_{i} - {m}_{k} ‖}_{2} )$$

$${H}_{i}^{T} = {E}^{T} ( {X}_{i}^{T} )$$

where [symbol] ^{CSA} is the self-supervised alignment loss, E^{T} is the encoder, M^{T} is the target domain mapping module, E is the representation symbol for all encoders, i, k and j are sequential numbers of the data, X is the source domain data and the target domain data, X^{S} is the source domain data set, X^{T} is a target domain data set, sim_{i,k}: is a density ratio, m is a scaling of a latent feature H by a mapping module, Hᵢ^{T} is a latent feature of a sample Xᵢ, and τ₁ and ε₁ are hyperparameters.

In a fifth aspect, the present application provides a cross-domain transfer device for a prediction model, including:
a memory;
a processor;
where the memory stores computer execution instructions;
the processor executes the computer execution instructions stored in the memory to implement the cross-domain transfer method for the prediction model as described in the first and second aspects and various possible implementations of the first and second aspects.

In a sixth aspect, the present application provides a computer-readable storage medium, a computer program is stored thereon, when the computer program is executed by a processor, the cross-domain transfer method for the prediction model as described in the first aspect and various possible implementation of the first aspect is implemented.

According to the cross-domain transfer method, apparatus and device for the prediction model, and the storage medium provided by the present application, the source domain data in the source domain is acquired, the contrastive domain generalization loss of the source domain is determined according to the first latent feature and a label of the source domain data, and the source domain model is pre-trained to obtain the pre-trained model, the pre-trained model is then transferred to the target domain to adapt to the target domain and form the target domain model. By acquiring the target domain data, the second latent feature and the pseudo label of the target domain data are determined, the instance-wise adversarial loss, self-supervised alignment loss, and pseudo domain generalization loss of the target domain data are determined according to the second latent feature, the pseudo label, the source domain data, the first latent feature and the label, and the target domain model is calibrated to obtain the target model. In this method, the pre-trained model is directly transferred to the target domain, the model is calibrated in the target domain, thereby adapting a similarity of the source domain data to the target domain, and improving an accuracy of cross-domain transfer of the model.

### BRIEF DESCRIPTION OF DRAWINGS

Accompanying drawings herein are incorporated into the specification and form a part of the specification, illustrating embodiments in accordance with the present application, and used together with the specification to explain principles of the present application.

FIG. 1 is a first flowchart diagram of a cross-domain transfer method for a prediction model provided by the present application.

FIG. 2 is a second flowchart diagram of a cross-domain transfer method for a prediction model provided by the present application.

FIG. 3 is a structural diagram of a cross-domain transfer apparatus for a prediction model provided by the present application.

FIG. 4 is a structural diagram of a cross-domain transfer apparatus for a prediction model provided by the present application.

FIG. 5 is a structural diagram of a cross-domain transfer device for a prediction model provided by the present application.

Through the above accompanying drawings, specific embodiments of the present application have been shown, and more detailed descriptions will be provided in the following text. These accompanying drawings and textual descriptions are not intended to limit a scope of the present application in any way, but rather to illustrate a concept of the present application for those skilled in the art by referring to the specific embodiment.

### DESCRIPTION OF EMBODIMENTS

Exemplary embodiments will be described in detail here, with examples shown in accompanying drawings. In the following description, when referring to the accompanying drawings, unless otherwise indicated, same numbers in different drawings represent the same or similar elements. Implementations described in the following exemplary embodiments do not represent all implementations consistent with the present application. On the contrary, they are only examples of apparatus and methods consistent with some aspects of the present application as described in the accompanying claims, and not all embodiments. Based on the embodiment of the present invention, all other embodiments obtained by those ordinary skilled in the art without paying creative labor are within a protection scope of the present invention.

Terms “first”, “second”, “third”, “fourth” and the like (if any) in the specification and claims of the present invention and the accompanying drawings are used to distinguish similar objects and do not necessarily describe a specific order or sequence. It should be understood that, data used in this way can be interchanged in appropriate circumstances, so that the embodiments of the present invention described herein can be implemented in order other than those illustrated or described herein. In addition, the terms “include” and “have”, as well as any variations thereof, are intended to cover non-exclusive inclusions. For example, processes, systems, products, or devices that contain a series of steps or units that are not necessarily limited to those steps or units clearly listed, but may include other steps or units that are not clearly listed or inherent to these processes, products, or devices.

In the embodiments of the present application, words such as “exemplary” or “for example” are used to indicate examples, illustrations, or explanations. Any embodiments or designs described as “exemplary” or “for example” in the present application should not be interpreted as being more preferred or advantageous than other embodiments or designs. Specifically, the use of words such as “exemplary” or “for example” is intended to present relevant concepts in a concrete way.

Firstly, the term involved in the present application is explained.

Source domain: the source domain refers to a dataset or a data distribution that has already been got, which is used for training model(s). This dataset is typically labeled and used for a supervised learning task. In the source domain, these annotated samples can be used to construct and train the model, and enable the model to learn a mapping relationship between input data and an output label.

Target domain: the target domain refers to a new dataset or data distribution to which we want to apply the model. In the target domain, there may have few or no labeled samples. Therefore, knowledge and features learned from the source domain need to be applied to the target domain through transfer learning, so as to improve performance in the target domain.

Mutual information: the mutual information is an indicator used in an information theory to measure an interdependence between two random variables. In machine learning and data analysis, the mutual information is commonly used to evaluate a correlation and a degree of information sharing between two variables. The larger the value of mutual information, the higher the correlation between two variables and the greater the degree of information sharing.

Generalization: the generalization refers to a capability of a model to handle new data, that is, the capability of the model to apply the knowledge learned on the training set to a test set or a new dataset. The stronger the generalization capability of the model, the better the performance in handling unknown data.

Predictor: the predictor is a model or algorithm used to predict a remaining useful life of a device or system. The predictor typically makes predictions according to historical data, sensor information, and machine learning algorithms.

Contrastive domain generalization loss: the contrastive domain generalization loss helps the model to learn the generalization capability, by comparing a similarity between data samples in different domains. It is usually achieved by maximizing the similarity between samples in the same category and minimizing the similarity between samples in different categories.

Self-supervised alignment loss: the self-supervised alignment loss aims to learn a representation that makes samples in the same category closer in a representation space and samples in the different categories more dispersed in the representation space. A contrastive loss is learned and expressed by comparing the similarity between samples, usually including a contrastive of positive sample pairs and negative sample pairs.

Cross-domain transfer refers to a process of applying the model that has already been trained in one domain to another domain. The cross-domain transfer involves two key concepts: the source domain and the target domain. The source domain refers to a domain that already has sufficient data, while the target domain refers to a new domain whose performance needs to be improved. The main process is to achieve better performance in the target domain by learning knowledge from the source domain. In the industrial field, due to a high cost of data acquisition and annotation, there is usually a large amount of unlabeled data; while in practical applications, it may be necessary to migrate existing models to new industrial scenarios.

Cross-domain transfer techniques typically include methods such as domain adaptation and transfer learning. The domain adaptation aims to reduce a distribution difference between the source domain and the target domain, in order to improve a generalization capability of the model on the target domain. The transfer learning helps with a learning task in the target domain by utilizing the knowledge of data in the source domain, reducing a requirement for data in the target domain. This mainly includes: training a model in the source domain; transferring a source domain model to the target domain for fine-tuning.

Existing industrial data prediction methods usually assume that monitored data follows an assumption of being independent and identically distributed, but due to a complexity and variability of industrial processes, this is usually not true. The monitored data may exhibit a distribution bias, leading to a decrease in the performance of a prediction model. Although there are many mature transfer learning methods, most of them are designed for a classification task, and there are few methods developed for a regression prediction task. Most transfer learning method cannot be used for a regression task.

In view of the above problems, the present application proposes a cross-domain transfer method for a prediction model. Firstly, a pre-trained model is trained in the source domain, and the generalization capability of the pre-trained model is improved by the contrastive domain generalization loss. In the process of fine-tuning the model for the target domain, mutual information between latent features and the original data is captured by a comparative self-supervised alignment method, further improving adaptive performance of the target domain; meanwhile, through an instance-wise adversarial discrimination, an adversarial discriminator module of a traditional domain-adversarial network is optimized to explore a domain invariance between data in the source domain (source domain data) and data in the target domain (target domain data). A purpose is to improve an accuracy of cross-domain data prediction by analyzing the correlation between the source domain data and target domain data.

Through the cross-domain transfer method for the prediction model proposed in the present application, a target model can be determined and directly used in the practical scenario. In a practical application process of the target model, real monitored data is obtained through a sensor of an industrial instrument, and the monitored data is input into an encoder of the target model to obtain a latent feature of the real data. Then, the latent feature of the real data is input into the predictor of the target model to obtain a real-time prediction result. The target model is a model with high prediction accuracy since it is subject to two rounds of training and calibration in the source domain and the target domain. The real-time prediction result is a result that has a strong correlation with the real monitored data.

A detailed explanation of technical solutions of the present application and how the technical solution of the present application solves the above technical problem is described below through specific embodiments. The following specific embodiments can be combined with each other, and the same or similar concepts or processes may not be repeated in some embodiments. The embodiments of the present application will be described in combination with the accompanying drawings.

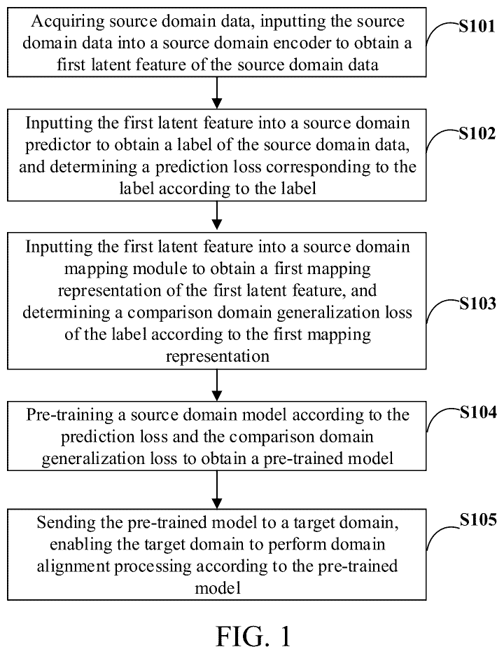

FIG. 1 shows a first flowchart of a cross-domain transfer method for a prediction model provided by an embodiments of the present application. This embodiment is applied to a source domain. As shown in FIG. 1, the method includes:

S101: acquiring source domain data, inputting the source domain data into a source domain encoder to obtain a first latent feature of the source domain data.

Where a symbol representation of the source domain data is

$${D}^{S} = {\{ {X}_{i}^{S} , {y}_{i}^{S} \}}_{i = 1}^{{n}_{S}} .$$

The symbol representation of the source domain encoder is E^{S}, and the symbol representation for extracting the first latent feature is H^{S}=E^{S}(X^{S}).

It is understandable that there are usually a large number of labeled samples available for learning in the source domain, which are used to train and construct an initial model. The source domain can be a task, a domain, or a dataset, and a selection of the source domain varies according to actual application scenarios. For example, the source domain can be a size, operating status, and operating data of an industrial machinery in the industrial field. Data in the source domain can be obtained through sensors in the source domain. Then the obtained source domain data is input into the source domain encoder to extract the latent feature of the source domain data. That is, an input of the source domain encoder is the source domain data, and an output is the first latent feature. Extraction of the latent feature is to better understand data, discover correlations/associations and regularities between the data.

Step 102: inputting the first latent feature into a source domain predictor to obtain a label of the source domain data, and determining a prediction loss corresponding to the label.

It can be understood that, the source domain predictor is a machine learning model used for domain adaptation, which can determine the label of the source domain data through the first latent feature and also predict a prediction label. In order to minimize a difference between the prediction label and the label, a mean square error of the prediction label is calculated, and a parameter of the predictor is optimized using the mean square error, so as to make a prediction result closer to a true result. The prediction loss refers to the mean square error of the prediction label. In the present application, [symbol] _{MSE} is used to represent the prediction loss and the mean square error, and the symbol of the predictor is P.

Step 103: inputting the first latent feature into a source domain mapping module to obtain a first mapping representation of the first latent feature, and determining a contrastive domain generalization loss of the label according to the first mapping representation.

It can be understood that, the source domain mapping module serves to scale a dimension of a latent feature, so that the latent feature and the source domain data are in the same dimension, thus a relationship between the data and the latent feature can be better understood. In a regression task, a trend of labels is correlated with a trend of features. To obtain this correlation, the contrastive domain generalization loss is used to maximize the mutual information between the feature of the source domain and the label. The contrastive domain generalization loss helps the model to learn the generalization capability, by comparing the similarity between data samples. A specific definition formula is as follows:

$${ℒ}_{CDG} = arg {min}_{{E}^{\text{?}} , {M}^{\text{?}}} {𝔼}_{X , y ∈ {𝒳}^{s}} - log {\sum }_{i} [ \frac{{\sum }_{\vert k \neq i} exp ( - τ {sim}_{i , k} \cdot \vert {y}_{i} - {y}_{k} \vert )}{{\sum }_{j \neq i} exp ( - τ \vert {y}_{i} - {y}_{j} \vert )} + ε ]$$

$${sim}_{i , k} = exp ( - {‖ {m}_{i} - {m}_{k} ‖}_{2} )$$

$${H}_{i} = {E}^{S} ( {X}_{i} )$$

$$\text{?} \text{indicates text missing or illegible when filed}$$

where sim_{i,k} is a density ratio, Hᵢ is the latent feature of the sample Xᵢ, yᵢ is the label of Xᵢ, and τ and ε are hyperparameters. [symbol] _{CDG} maximizes the mutual information by pulling the features with similar labels closer together and pushing the features with significant label differences further apart.

Step 104: pre-training a source domain model according to the prediction loss and the contrastive domain generalization loss to obtain a pre-trained model.

In an implementation, the prediction loss is integrated with the contrastive domain generalization loss to determine an integration result.

A parameter in the source domain model is updated according to the integration result to obtain the pre-trained model.

It can be understood that, in a training process of the source domain, the contrastive domain generalization loss is integrated with the prediction loss from the label to form a loss function of the source domain model. The formula of the loss function is as follows:

$${ℒ}_{Source} = {ℒ}_{MSE} + {ℒ}_{CDG}$$

[symbol] _{MSE} is used to optimize and update the encoder and the predictor in the source domain model, [symbol] _{CDG} is used to update and optimize the encoder and the mapping module in the source domain model, and the pre-trained model is determined according to the updated and optimized encoder and predictor.

S105: sending the pre-trained model to a target domain, enabling the target domain to perform domain alignment processing according to the pre-trained model.

It can be understood that, after the pre-trained model is determined, the pre-trained model is directly transferred to the target domain, and the target domain can be adaptively trained according to the pre-trained model, so that the pre-trained model can adapt to the target domain data and can be calibrated in the target domain.

According to the cross-domain transfer method for the prediction model provided by this embodiment, the source domain data is acquired and input into the source domain encoder to obtain the first latent feature of the source domain data; the first latent feature is input into the source domain predictor to obtain the label of the source domain data, and the prediction loss corresponding to the label is determined; the first latent feature is input into the source domain mapping module to obtain the first mapping representation of the first latent feature, and the contrastive domain generalization loss of the label is determined; the source domain model is pre-trained according to the prediction loss and contrastive domain generalization loss to obtain the pre-trained model; and the pre-trained model is sent to the target domain, which enables the target domain to perform the domain alignment processing according to the pre-trained model. In this method, the model is pre-trained using the source domain data, the strong correlation between the feature and label of the source domain data is acquired and sent to the target domain, so that the target domain can make data prediction according to the correlation.

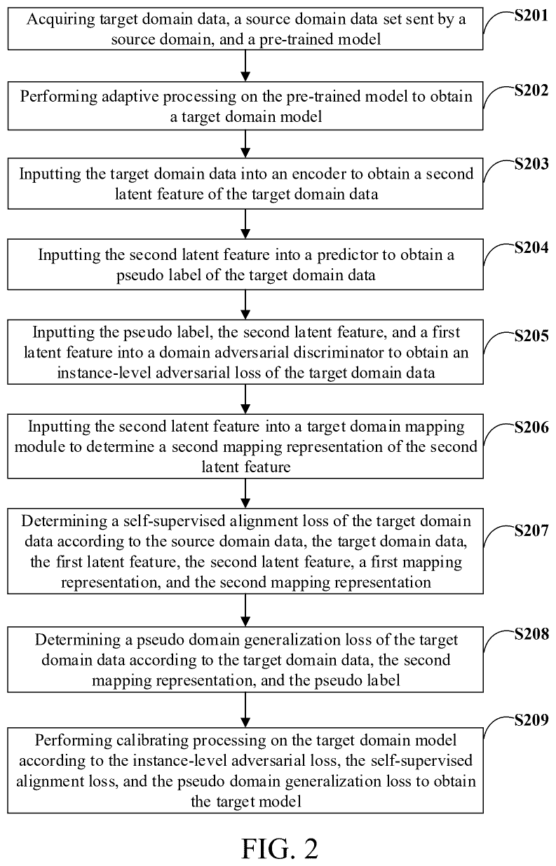

FIG. 2 is a second flowchart diagram of a cross-domain transfer method for a prediction model provided by an embodiment of the present application. This embodiment is applied to a target domain. As shown in FIG. 2, the method includes:

S201: acquiring target domain data, a source domain data set sent by a source domain, and a pre-trained model, where the pre-trained model includes an encoder and a predictor, and the source domain data set includes source domain data, a first latent feature of the source domain data, and a first mapping representation of the source domain data.

Where a symbol representation of the target domain data is

$${D}^{T} = {\{ {X}_{i}^{T} \}}_{i = 1}^{{n}_{T}} .$$

It can be understood that, the target domain is a part to which we want to make a model applicable, and most data in the target domain is not labeled, a relationship between features and labels that learned in the source domain should be applied to the target domain through a transfer method. Therefore, a pre-trained model in the source domain is required, and this model should be adapted to the target domain and run normally in the target domain. Similarly, it is necessary to use sensors in the target domain to obtain data in the target domain before calibrating the model.

S202: performing adaptive processing on the pre-trained model to obtain a target domain model, where the target domain model includes an encoder, a predictor, a domain adversarial discriminator, and a target domain mapping module.

It can be understood that, the encoder and predictor of the pre-trained model have already been trained and updated, and have a certain optimization effect, which can help the target domain with faster learning and training. Meanwhile, the pre-trained model may contain some general features and knowledge that may also be useful for the target domain. The adaptive processing performed on the pre-trained model can enable the pre-trained model to better integrate with the target domain, meanwhile, a module required for the domain alignment processing in the target domain is introduced, ultimately generating the target domain model that conforms to the target domain.

S203: inputting the target domain data into the encoder to obtain a second latent feature of the target domain data.

Where the symbol representation of the encoder is E^{T}, and the symbol representation of the second latent feature H^{T}=E^{T}(X^{T}).

It can be understood that, the encoder is the same as the trained source domain encoder, and extraction of the second latent feature of the target domain data using the same encoder can make a feature extraction method of the target domain data the same as that of the source domain data, thereby better enabling the target domain model to learn the correlation between the data and feature in the source domain.

Step 204: inputting the second latent feature into the predictor to obtain a pseudo label of the target domain data.

Where the predictor and the predictor of the pre-trained model are the same predictor, so symbol representation methods are the same.

It can be understood that, the target domain data refers to a dataset that needs to be predicted, while the second latent feature refers to a feature that may have an impact on the target domain data. By inputting the second latent feature into the predictor, the pseudo label of the target domain data can be obtained. The pseudo label refers to the label predicted by the model, which can be used as a part of training data to improve the performance and generalization capability of the model. Because the predictor is the same as the source domain predictor, they predict labels in the same way, so they can better adapt to the correlation between the feature and label. In this process, by combining the target domain data with the latent feature, the predictor can generate the pseudo label, so as to help the model to better predict the target domain data, thereby further optimizing a predictive capability and generalization performance of the model.

S205: inputting the pseudo label, the second latent feature, and the first latent feature into the domain adversarial discriminator to obtain an instance-wise adversarial loss of the target domain data.

It should be understood that, due to a distribution difference of data, the model cannot accurately predict the label of the target domain data. To this end, the model is retrained with an adversarial training method, so as to explore a domain invariance between two data domains. However, two samples with a significant difference in labels are naturally prone to be classified into different categories. Therefore, the impact of unnecessary classification result can be minimized by weighting the classification result.

In an implementation, weights of the source domain data and the target domain data are determined according to the pseudo label. The weights, the second latent feature, and the first latent feature are input into the domain adversarial discriminator to determine the instance-wise adversarial loss of the target domain data.

The following formula is adopted to determine the instance-wise adversarial loss:

$${ℒ}_{iadv} = arg {min}_{{E}^{T}} {max}_{D} [ {𝔼}_{{X}^{S}} [ log ( {w}^{S} * D ( {E}^{S} ( {X}^{S} ) ) ) ] + [ {𝔼}_{{X}^{T}} [ log ( {w}^{T} * ( 1 - D ( {E}^{T} ( {X}^{T} ) ) ) ) ]$$

$${w}_{i}^{S} = φ \cdot \frac{{\sum }_{k} exp ( - \vert {\hat{y}}_{i} - {\hat{y}}_{k} \vert / L )}{{n}^{T}} + ( 1 - φ )$$

$${w}_{k}^{T} = φ \cdot \frac{{\sum }_{i} exp ( - \vert {\hat{y}}_{k} - {\hat{y}}_{i} \vert / L )}{{n}^{S}} + ( 1 - φ )$$

where [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain, wᵢ^{S} is a weight of i-th data in the source domain data,

$${w}_{k}^{T}$$

is a weight of k-th data in the target domain data, ŷᵢ and ŷₖ are pseudo labels of the i-th data in the source domain data and the k-th data in the target domain data, respectively; L is an approximate value range of the labels, φ is a hyperparameter, E^{S} is the source domain encoder, E^{T} is the encoder, X^{S} is the first latent feature, X^{T} is the second latent feature.

It can be understood that, the symbol presentation of the domain adversarial discriminator is D. In the instance-wise adversarial loss, a goal of the source domain encoder and the encoder is to confuse their own latent features, making it impossible for the discriminator to distinguish a source of latent features, while the goal of the discriminator is to accurately distinguish between the first latent feature and the second latent feature. This adversarial competition drives the discriminator to continuously improve its discriminative capability. A design of such loss function creates an adversarial training process between the encoder and the discriminator, making the source domain data more similar to the target domain data and minimizing a domain difference.

S206: inputting the second latent feature into the target domain mapping module to determine a second mapping representation of the second latent feature.

It can be understood that, similar to a role of the source domain mapping module, the role of the target domain mapping module is to reduce its dimension to make it the same as that of the target domain data, in order to reduce a computational complexity.

The symbol representation of the second mapping representation is

$${m}^{T} = {M}^{T} ( {H}^{T} ) .$$

S207: determining a self-supervised alignment loss of the target domain data according to the source domain data, the target domain data, the first latent feature, the second latent feature, the first mapping representation, and the second mapping representation.

It can be understood that, in order to prevent an adversarial domain adaptation from deleting task-specific information from a target feature, the self-supervised alignment loss is used to preserve task-specific domain invariant information. Similar to the contrastive domain generalization loss [symbol] _{CDG}, even if the data belongs to different domains, we still assume a certain correlation between a trend of labels and a trend of features. However, in a domain adaptation task, the label of the target domain data is invisible. Therefore, we need to capture a domain invariance of data features in the different domains. The source domain data with similar labels is represented as similar latent features using [symbol] _{CDG}. The data with similar features is represented as similar latent features using [symbol] _{CSA}.

In an implementation, the following formula is adopted to determine the self-supervised alignment loss:

$${ℒ}_{CSA} = arg {min}_{{E}^{T} , {M}^{T}} {𝔼}_{\vert X ∈ \{ {𝒳}^{S} ⋃ {𝒳}^{T} \}} - log {\sum }_{i} [ \frac{{\sum }_{k} exp ( - {τ}_{1} {sim}_{i , k} \cdot {‖ {X}_{i} - {X}_{k} ‖}_{2} )}{{\sum }_{j} exp ( - {τ}_{1} {‖ {X}_{i} - {X}_{j} ‖}_{2} )} + {ε}_{1} ]$$

$${sim}_{i , k} = exp ( - {‖ {m}_{i} - {m}_{k} ‖}_{2} )$$

$${H}_{i}^{T} = {E}^{T} ( {X}_{i}^{T} )$$

where [symbol] _{CSA} is the self-supervised alignment loss, E^{T} is the encoder, M^{T} is the target domain mapping module, E is a representation symbol for all encoders, i, k, and j are sequential numbers of data, X is the source domain data and the target domain data, X^{S} is the source domain data set, X^{T} is a target domain data set, sim_{i,k} is a density ratio, m is a scaling of a latent feature H operated by a mapping module,

$${H}_{i}^{T}$$

is a latent feature of a sample Xᵢ, τ₁ and ε₁ are hyperparameters. It can be understood that, the self-supervised alignment loss learns the representation through the similarity between sample pairs, a first sample pair refers to the first latent feature and label. By comparing and learning according to the correlation between the first latent feature and label, the label representation in a second sample pair is determined, and the second sample pair is the second latent feature and label.

Simultaneously, using the self-supervised alignment loss can further improve adaptive performance of the target domain.

S208: determining a pseudo domain generalization loss of the target domain data according to the target domain data, the second mapping representation, and the pseudo label.

The following formula is adopted to determine the pseudo domain generalization loss:

$${ℒ}_{PCDG} = arg {min}_{{E}^{T} , {M}^{T}} {𝔼}_{𝒳 ∈ {𝒳}^{T}} - log {\sum }_{i} [ \frac{{\sum }_{k \neq i} exp ( - {τ}_{2} {sim}_{i , k} \cdot \vert {\hat{y}}_{i} - {\hat{y}}_{k} \vert )}{{\sum }_{j \neq i} exp ( - {τ}_{2} \vert {\hat{y}}_{i} - {\hat{y}}_{j} \vert )} + {ε}_{2} ]$$

$${sim}_{i , k} = exp ( - {‖ {m}_{i} - {m}_{k} ‖}_{2} )$$

$${\hat{y}}_{i} = R ( {E}^{T} ( {x}_{i}^{T} )$$

where [symbol] is the target domain data set, sim_{i,k} is the density ratio, m is the scaling of the latent feature H operated by the mapping module, ŷᵢ is the pseudo label of Xᵢ, τ₂ and ε₂ are hyperparameters.

It can be understood that, an output of the target domain predictor is regarded as the pseudo label of the target domain data, which is, together with the output of the target domain mapping module, used to calculate the pseudo domain generalization loss, thus further capturing mutual information between data and labels in the target domain, and then constructing correlation for the second latent feature. An introduction of the pseudo domain generalization loss helps the target domain model to reduce over-fitting with respect to specific domains, thereby improving generalization performance of the target domain model in unknown domains, and making it more adaptable and robust to data changes in the unknown domain.

S209: performing calibrating processing on the target domain model according to the instance-wise adversarial loss, the self-supervised alignment loss, and the pseudo domain generalization loss to obtain the target model, where the target model includes a calibrated encoder and a calibrated predictor.

It can be understood that, by jointly optimizing the instance-wise adversarial loss, the self-supervised alignment loss, and the pseudo domain generalization loss, a formula of an overall loss function in the target domain is as follows:

$${ℒ}_{Target} = {ℒ}_{iadv} + {ℒ}_{CSA} + {λℒ}_{PCDG}$$

$$ℒ = {ℒ}_{CSA} + {λℒ}_{PCDG}$$

where the domain adversarial discriminator and the encoder can be updated and calibrated by [symbol] _{iadv}, and the encoder and the target domain mapping module can be updated and calibrated by L. The calibrated encoder and predictor are both in the target model, then the target model can be directly used for predicting real data with high prediction accuracy.

According to the cross-domain transfer method for the prediction model provided by this embodiment, the target domain data, the source domain data set sent by the source domain and the pre-trained model are acquired, adaptive processing is performed on the pre-trained model to obtain the target domain model, the target domain data is input into the encoder to obtain the second latent feature of the target domain data; the second latent feature is input into the predictor to obtain the pseudo label of the target domain data; the second latent feature is input into the target domain mapping module to determine the second mapping representation of the second latent feature; the instance-wise adversarial loss, the self-supervised alignment loss, and the pseudo domain generalization loss of the target domain data are determined according to the target domain data, the second latent feature, the pseudo label, and the second mapping representation; and the target domain model is calibrated to obtain the target model. In this method, the target domain model in the target domain is calibrated to adapt the similarity of the source domain data to the target domain, thereby improving cross-domain accuracy.

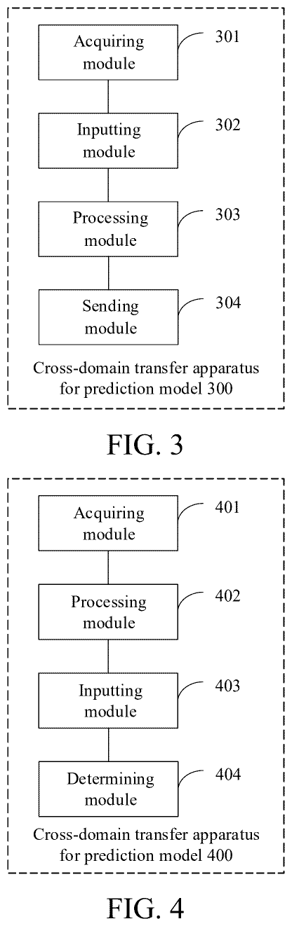

FIG. 3 is a structural diagram of a cross-domain transfer apparatus for a prediction model provided by the present application. As shown in FIG. 3, the cross-domain transfer apparatus for the prediction model 300 provided by the present application is applied to a source domain, including:
an acquiring module 301, configured to acquire source domain data, input the source domain data into a source domain encoder to obtain a first latent feature of the source domain data;
an input module 302, configured to input the first latent feature into a source domain predictor to obtain a label of the source domain data, and determine a prediction loss corresponding to the label;
the input module 302 is further configured to input the first latent feature into a source domain mapping module to obtain a first mapping representation of the first latent feature, and determine a contrastive domain generalization loss of the label according to the first mapping representation;
a processing module 303, configured to pre-train a source domain model according to the prediction loss and the contrastive domain generalization loss to obtain a pre-trained model;
a sending module 304, configured to send the pre-trained model to a target domain, and enable the target domain to perform domain alignment processing according to the pre-trained model.

In an implementation, the processing module 303 is further configured to integrate the prediction loss and the contrastive domain generalization loss to determine an integration result;
the processing module 303 is further configured to update a parameter in the source domain model according to the integration result to obtain the pre-trained model.

FIG. 4 is a structural diagram of a cross-domain transfer apparatus for a prediction model provided by the present application. As shown in FIG. 4, the cross-domain transfer apparatus for the prediction model 400 provided by the present application is applied to a target domain, including:
an acquiring module 401, configured to acquire target domain data, a source domain data set sent by a source domain, and a pre-trained model, where the pre-trained model includes an encoder and a predictor, and the source domain data set includes source domain data, a first latent feature of the source domain data, and a first mapping representation of the source domain data;
a processing module 402, configured to perform adaptive processing on the pre-trained model to obtain a target domain model, where the target domain model includes an encoder, a predictor, a domain adversarial discriminator, and a target domain mapping module;
an input module 403, configured to input the target domain data into the encoder to obtain a second latent feature of the target domain data;
the input module 403 is further configured to input the second latent feature into the predictor to obtain a pseudo label of the target domain data;
the input module 403 is further configured to input the pseudo label, the second latent feature, and the first latent feature into the domain adversarial discriminator to obtain an instance-wise adversarial loss of the target domain data;
the input module 403 is further configured to input the second latent feature into the target domain mapping module to determine a second mapping representation of the second latent feature;
a determining module 404, configured to determine a self-supervised alignment loss of the target domain data according to the source domain data, the target domain data, the first latent feature, the second latent feature, the first mapping representation, and the second mapping representation;
the determining module 404 is further configured to determine a pseudo domain generalization loss of the target domain data according to the target domain data, the second mapping representation, and the pseudo label;
the determining module 404 is further configured to perform calibrating processing on the target domain model according to the instance-wise adversarial loss, the self-supervised alignment loss, and the pseudo domain generalization loss to obtain a target model, where the target model includes a calibrated encoder and a calibrated predictor.

In an implementation, the determining module 404 is configured to determine weights of the source domain data and the target domain data according to the pseudo label;
the input module 403 is further configured to input the weights, the second latent feature, and the first latent feature into the domain adversarial discriminator to determine the instance-wise adversarial loss of the target domain data.

In an implementation, the input module 404 is further configured to input the second latent feature, and the first latent feature into the domain adversarial discriminator to determine the instance-wise adversarial loss using the following formula:

$${ℒ}_{iadv} = arg {min}_{{E}^{T}} {max}_{D} [ {𝔼}_{{X}^{S}} [ log ( {w}^{S} * D ( {E}^{S} ( {X}^{S} ) ) ) ] + {𝔼}_{{X}^{T}} [ log ( {w}^{T} * ( 1 - D ( {E}^{T} ( {X}^{T} ) ) ) ) ] \\ {w}_{i}^{S} = φ \cdot \frac{{\sum }_{k} exp ( - \vert {\hat{y}}_{i} - {\hat{y}}_{k} \vert / L )}{{n}^{T}} + ( 1 - φ ) \\ {w}_{k}^{T} = φ \cdot \frac{{\sum }_{i} exp ( - \vert {\hat{y}}_{k} - {\hat{y}}_{i} \vert / L )}{{n}^{S}} + ( 1 - φ )$$

where [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain,

$${w}_{i}^{S}$$

is a weight of i-th data in the source domain data,

$${w}_{k}^{T}$$

is a weight of k-th data in the target domain data, ŷᵢ and ŷₖ are pseudo labels of the i-th data in the source domain data and the k-th data in the target domain data, respectively; L is an approximate value range of the labels, φ is a hyperparameter, E^{S} is the source domain encoder, E^{T} is the encoder, X^{S} is the first latent feature, X^{T} is the second latent feature.

In an implementation, the determining module 404 is further configured to determine the self-supervised alignment loss using the following formula:

$${ℒ}_{CSA} = arg {min}_{{E}^{T} , {M}^{T}} {𝔼}_{\vert X ∈ \{ {χ}^{S} ⋃ {χ}^{T} \}} - log {\sum }_{i} [ \frac{{\sum }_{k} exp ( - {τ}_{1} {sim}_{i , k} \cdot {‖ {X}_{i} - {X}_{k} ‖}_{2} )}{{\sum }_{j} exp ( - {τ}_{1} {‖ {X}_{i} - {X}_{j} ‖}_{2} )} + {ε}_{1} ] \\ {sim}_{i , k} = exp ( - {‖ {m}_{i} - {m}_{k} ‖}_{2} ) \\ {H}_{i}^{T} = {E}^{T} ( {X}_{i}^{T} )$$

where [symbol] _{CSA} is the self-supervised alignment loss, E^{T} is the encoder, M^{T} is the target domain mapping module, E is the representation symbol for all encoders, i, k, and j are sequential numbers of data, X is the source domain data and the target domain data, X^{S} is the source domain data set, X^{T} is the target domain data set, sim_{i,k}: is the density ratio, m is a scaling of a latent feature H operated by a mapping module,

$${H}_{i}^{T}$$

is the latent feature of the sample Xᵢ, τ₁ and ε₁ are hyperparameters.

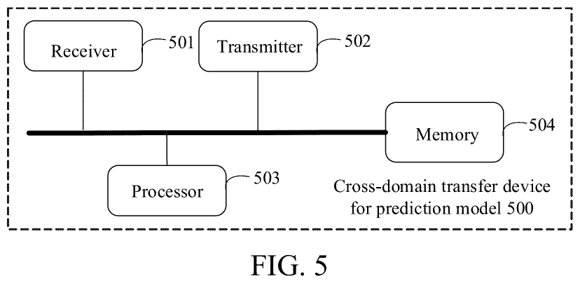

FIG. 5 is a structural diagram of a cross-domain transfer device for a prediction model provided by the present application. As shown in FIG. 5, the present application provides the cross-domain transfer device for the prediction model. The cross-domain transfer device for the prediction model 500 includes a receiver 501, a transmitter 502, a processor 503, and a memory 504.

The receiver 501, configured to receive instructions and data;
the transmitter 502, configured to send the instruction and data;
the memory 504, configured to store computer execution instructions;
the processor 503, configured to execute the computer execution instructions stored in the memory 504 to implement the various steps of the cross-domain transfer method for the prediction model in the above embodiments. For specific details, reference may be made to relevant descriptions in the embodiment of the cross-domain transfer method for the prediction model.

In an implementation, the above-mentioned memory 504 can be independent or integrated with the processor 503.

When the memory 504 is independently arranged, the cross-domain transfer device also includes a bus for connecting the memory 504 and the processor 503.

The present application also provides a computer-readable storage medium, the computer-readable storage medium stores computer execution instructions; when a processor executes the computer execution instructions, the cross-domain transfer method for the prediction model executed by the cross-domain transfer device for the prediction model as described above is implemented.

Those ordinary skilled in the art can understand that all or some of steps in the disclosed methods, systems, and functional modules/units in apparatus can be implemented as software, firmware, hardware, and appropriate combinations thereof. In a hardware implementation, a division between functional modules/units mentioned in the above description does not necessarily correspond to the division of physical components. For example, one physical component can have multiple functions, or one function or step can be executed collaboratively by several physical components. Some or all physical components can be implemented as the software executed by a processors such as a central processing unit, a digital signal processor, or a microprocessor, or implemented as the hardware, or implemented as an integrated circuit such as an application specific integrated circuit. Such software can be distributed on a computer-readable medium, which can include a computer storage medium (or non-temporary medium) and a communication medium (or a temporary medium). As is well known to those ordinary skilled in the art, the term computer storage medium includes volatile and non-volatile, removable and non-removable medium implemented in any method or technology for storing information, such as computer-readable instructions, data structures, program modules, or other data. The computer storage medium includes but is not limited to RAM, ROM, EEPROM, flash memory or other storage technologies, CD-ROM, digital versatile disks (DVD) or other optical storage, magnetic cartridges, magnetic tapes, magnetic disk storage or other magnetic storage devices, or any other medium that can be used to store desired information and can be accessed by a computer. In addition, it is well known to those ordinary skilled in the art that the communication medium typically includes computer-readable instructions, data structures, program modules, or other data in modulated data signals such as carriers or other transmission mechanisms, and may include any information delivery medium.

Those skilled in the art will easily come up with other embodiments of the present application after considering the specification and practicing the invention disclosed herein. The present application is intended to cover any variations, uses, or adaptive changes of the present application, which follow a general principle of the present application and include common knowledge or customary technical means in the art not disclosed in the present application. The specification and embodiment are only considered exemplary, and a true scope and spirit of the present application are indicated by the following claims.

It should be understood that, the present application is not limited to a precise structure described above and shown in the accompanying drawings, and various modifications and changes can be made without departing from its scope. The scope of the present application is limited only by the appended claims.

What is claimed is:

1. A cross-domain transfer method for a prediction model, applied to a source domain, wherein the source domain comprises a source model, and the source model comprises a source domain encoder, a source domain predictor and a source domain mapping module, the method comprises:
acquiring source domain data, inputting the source domain data into the source domain encoder to obtain a first latent feature of the source domain data;
inputting the first latent feature into the source domain predictor to obtain a label of the source domain data, and determining a prediction loss corresponding to the label;
inputting the first latent feature into the source domain mapping module to obtain a first mapping representation of the first latent feature, and determining a contrastive domain generalization loss of the label according to the first mapping representation;
pre-training the source domain model according to the prediction loss and the contrastive domain generalization loss to obtain a pre-trained model;
sending the pre-trained model to a target domain, and enabling the target domain to perform domain alignment processing according to the pre-trained model.

2. The method according to claim 1, wherein the pre-training the source domain model according to the prediction loss and the contrastive domain generalization loss to obtain the pre-trained model, comprises:
integrating the prediction loss with the contrastive domain generalization loss to determine an integration result;
updating a parameter of the source domain model according to the integration result to obtain the pre-trained model.

3. A cross-domain transfer method for a prediction model, applied to a target domain and comprising:
acquiring target domain data, a source domain data set sent by a source domain, and a pre-trained model, wherein the pre-trained model comprises an encoder and a predictor, and the source domain data set comprises source domain data, a first latent feature of the source domain data, and a first mapping representation of the source domain data;
performing adaptive processing on the pre-trained model to obtain a target domain model, wherein the target domain model comprises an encoder, a predictor, a domain adversarial discriminator, and a target domain mapping module;
inputting the target domain data into the encoder to obtain a second latent feature of the target domain data;
inputting the second latent feature into the predictor to obtain a pseudo label of the target domain data;
inputting the pseudo label, the second latent feature, and the first latent feature into the domain adversarial discriminator to obtain an instance-wise adversarial loss of the target domain data;
inputting the second latent feature into the target domain mapping module to determine a second mapping representation of the second latent feature;
determining a self-supervised alignment loss of the target domain data according to the source domain data, the target domain data, the first latent feature, the second latent feature, the first mapping representation, and the second mapping representation;
determining a pseudo domain generalization loss of the target domain data according to the target domain data, the second mapping representation, and the pseudo label;
performing calibrating processing on the target domain model according to the instance-wise adversarial loss, the self-supervised alignment loss, and the pseudo domain generalization loss to obtain a target model, wherein the target model comprises a calibrated encoder and a calibrated predictor.

4. The method according to claim 3, wherein the inputting the pseudo label, the second latent feature, and the first latent feature into the domain adversarial discriminator to obtain the instance-wise adversarial loss of the target domain data, comprises:
determining weights of the source domain data and the target domain data according to the pseudo label;
inputting the weights, the second latent feature, and the first latent feature into the domain adversarial discriminator to determine the instance-wise adversarial loss of the target domain data.

5. The method according to claim 4, wherein the inputting the weights, the second latent feature, and the first latent feature into the domain adversarial discriminator to determine the instance-wise adversarial loss of the target domain data, comprises:
determining the instance-wise adversarial loss using the following formula:
$${ℒ}_{iadv} = arg {min}_{{E}^{T}} {max}_{D} [ {𝔼}_{{X}^{S}} [ log ( {w}^{S} * D ( {E}^{S} ( {X}^{S} ) ) ) ] + {𝔼}_{{X}^{T}} [ log ( {w}^{T} * ( 1 - D ( {E}^{T} ( {X}^{T} ) ) ) ) ] \\ {w}_{i}^{S} = φ \cdot \frac{{\sum }_{k} exp ( - \vert {\hat{y}}_{i} - {\hat{y}}_{k} \vert / L )}{{n}^{T}} + ( 1 - φ ) \\ {w}_{k}^{T} = φ \cdot \frac{{\sum }_{i} exp ( - \vert {\hat{y}}_{k} - {\hat{y}}_{i} \vert / L )}{{n}^{S}} + ( 1 - φ )$$
wherein [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain,
$${w}_{i}^{S}$$
is a weight of i-th data in the source domain data,
$${w}_{k}^{T}$$
is a weight of k-th data in the target domain data, ŷᵢ and ŷₖ are pseudo labels of the i-th data in the source domain data and the k-th data in the target domain data respectively, L is an approximate value range of the label, φ is a hyperparameter, E^{S} is a source domain encoder, E^{T} is the encoder, X^{S} is the first latent feature, X^{T} is the second latent feature.

6. The method according to claim 3, wherein the determining the self-supervised alignment loss of the target domain data according to the source domain data, the target domain data, the first latent feature, the second latent feature, the first mapping representation, and the second mapping representation, comprises:
determining the self-supervised alignment loss using the following formula:
$${ℒ}_{CSA} = arg {min}_{{E}^{T} , {M}^{T}} {𝔼}_{\vert X ∈ \{ {χ}^{S} ⋃ {χ}^{T} \}} - log {\sum }_{i} [ \frac{{\sum }_{k} exp ( - {τ}_{1} {sim}_{i , k} \cdot {‖ {X}_{i} - {X}_{k} ‖}_{2} )}{{\sum }_{j} exp ( - {τ}_{1} {‖ {X}_{i} - {X}_{j} ‖}_{2} )} + {ε}_{1} ] \\ {sim}_{i , k} = exp ( - {‖ {m}_{i} - {m}_{k} ‖}_{2} ) \\ {H}_{i}^{T} = {E}^{T} ( {X}_{i}^{T} )$$
wherein [symbol] _{CSA} is the self-supervised alignment loss, E^{T} is the encoder, M^{T} is the target domain mapping module, E is a representation symbol for all encoders, i, k and j are sequential numbers of data, X is the source domain data and the target domain data, X^{S} is the source domain data set, X^{T} is a target domain data set, sim_{i,k} is a density ratio, m is a scaling of a latent feature H by a mapping module,
$${H}_{i}^{T}$$
is a latent feature of a sample Xᵢ, and τ₁ and ε₁ are hyperparameters.

7. A cross-domain transfer apparatus for a prediction model, applied to a source domain, wherein the source domain comprises a source model, and the source model comprises a source domain encoder, a source domain predictor and a source domain mapping module, the apparatus comprises:
a memory;
a processor;
wherein the memory stores computer execution instructions;
the processor executes the computer execution instructions stored in the memory to:
acquire source domain data, input the source domain data into the source domain encoder to obtain a first latent feature of the source domain data;
input the first latent feature into the source domain predictor to obtain a label of the source domain data, and determine a prediction loss corresponding to the label;
input the first latent feature into the source domain mapping module to obtain a first mapping representation of the first latent feature, and determine a contrastive domain generalization loss of the label according to the first mapping representation;
pre-train the source domain model according to the prediction loss and the contrastive domain generalization loss to obtain a pre-trained model;
send the pre-trained model to a target domain, enabling the target domain to perform domain alignment processing according to the pre-trained model.

8. The method according to claim 7, wherein the processor further executes the computer execution instructions stored in the memory to:
integrate the prediction loss with the contrastive domain generalization loss to determine an integration result;
update a parameter of the source domain model according to the integration result to obtain the pre-trained model.

9. A cross-domain transfer apparatus for a prediction model, applied to a target domain, wherein the apparatus comprises:
a memory;
a processor;
wherein the memory stores computer execution instructions;
the processor executes the computer execution instructions stored in the memory to implement the cross-domain transfer method for the prediction model according to claim 3.

10. The method according to claim 9, wherein the processor further executes the computer execution instructions stored in the memory to:
determine weights of the source domain data and the target domain data according to the pseudo label;
input the weights, the second latent feature, and the first latent feature into the domain adversarial discriminator to determine the instance-wise adversarial loss of the target domain data.

11. The method according to claim 10, wherein the processor further executes the computer execution instructions stored in the memory to:
input the second latent feature, and the first latent feature into the domain adversarial discriminator to determine the instance-wise adversarial loss using the following formula:
$${ℒ}_{iadv} = arg {min}_{{E}^{T}} {max}_{D} [ {𝔼}_{{X}^{S}} [ log ( {w}^{S} * D ( {E}^{S} ( {X}^{S} ) ) ) ] + {𝔼}_{{X}^{T}} [ log ( {w}^{T} * ( 1 - D ( {E}^{T} ( {X}^{T} ) ) ) ) ] \\ {w}_{i}^{S} = φ \cdot \frac{{\sum }_{k} exp ( - \vert {\hat{y}}_{i} - {\hat{y}}_{k} \vert / L )}{{n}^{T}} + ( 1 - φ ) \\ {w}_{k}^{T} = φ \cdot \frac{{\sum }_{i} exp ( - \vert {\hat{y}}_{k} - {\hat{y}}_{i} \vert / L )}{{n}^{S}} + ( 1 - φ )$$
wherein [symbol] _{iadv} is the instance-wise adversarial loss, D is the domain adversarial discriminator, E is a representation symbol for all encoders, w^{S} is the weight of the source domain data, w^{T} is the weight of the target domain data, n^{T} is the amount of data in the target domain, n^{S} is the amount of data in the source domain,
$${w}_{i}^{S}$$
is a weight of i-th data in the source domain data,
$${w}_{k}^{T}$$
is a weight of k-th data in the target domain data, ŷᵢ and ŷₖ are pseudo labels of the i-th data in the source domain data and the k-th data in the target domain data respectively, L is an approximate value range of the label, φ is a hyperparameter, E^{S} is a source domain encoder, E^{T} is the encoder, X^{S} is the first latent feature, X^{T} is the second latent feature.

12. The method according to claim 9, wherein the processor further executes the computer execution instructions stored in the memory to:
determine the self-supervised alignment loss using the following formula:
$${ℒ}_{CSA} = arg {min}_{{E}^{T} , {M}^{T}} {𝔼}_{\vert X ∈ \{ {χ}^{S} ⋃ {χ}^{T} \}} - log {\sum }_{i} [ \frac{{\sum }_{k} exp ( - {τ}_{1} {sim}_{i , k} \cdot {‖ {X}_{i} - {X}_{k} ‖}_{2} )}{{\sum }_{j} exp ( - {τ}_{1} {‖ {X}_{i} - {X}_{j} ‖}_{2} )} + {ε}_{1} ] \\ {sim}_{i , k} = exp ( - {‖ {m}_{i} - {m}_{k} ‖}_{2} ) \\ {H}_{i}^{T} = {E}^{T} ( {X}_{i}^{T} )$$
wherein [symbol] _{CSA} is the self-supervised alignment loss, E^{T} is the encoder, M^{T} is the target domain mapping module, E is a representation symbol for all encoders, i, k and j are sequential numbers of data, X is the source domain data and the target domain data, X^{S} is the source domain data set, X^{T} is a target domain data set, sim_{i,k} is a density ratio, m is a scaling of a latent feature H by a mapping module,
$${H}_{i}^{T}$$
is a latent feature of a sample Xᵢ, and τ₁ and ε₁ are hyperparameters.

13. A computer-readable storage medium, wherein the computer-readable storage medium stores computer execution instructions; when the computer execution instructions are executed by a processor, the cross-domain transfer method for the prediction model according to claim 1 is implemented.

14. A computer-readable storage medium, wherein the computer-readable storage medium stores computer execution instructions; when the computer execution instructions are executed by a processor, the cross-domain transfer method for the prediction model according to claim 3 is implemented.
